(19) United States
(12) Patent Application Publication
(10) Pub. No.: US 2006/0137514 A1
(43) Pub. Date: Jun. 29, 2006

(54) Vibration-activated musical toy

(76) Inventor: Johnny Bong Wing Lai, Hong Kong (HK)

Correspondence Address: BAKER & MCKENZIE LLP;PATENT DEPARTMENT, 2001 ROSS AVENUE, SUITE 2300, DALLAS, TX, 75201, US

(21) Appl. No.: 11/277,720

(22) Filed: Mar. 28, 2006

(30) Foreign Application Priority Data
Oct. 14, 2005 (CN) 200510109307.6

(51) Int. Cl. G10H 1/00

(52) U.S. Cl. 84/600

(57) ABSTRACT

The present disclosure generally relates to a vibration-activated musical toy and methods for operating a vibration-activated musical toy. In one exemplary embodiment, a vibration-activated musical toy is described in which two separate modules are independently moved, shaken, struck, or otherwise manipulated in a particular order and in a particular rhythm to play a song. Related embodiments are also described.

### CROSS-REFERENCE TO RELATED APPLICATIONS

This application claims the benefit of PRC Application No. 200510109307.6 filed Oct. 14, 2005, which is incorporated herein by reference.

### TECHNICAL FIELD

The present disclosure generally relates to musical toys and methods for operating musical toys.

### BACKGROUND

Toys are designed to provide stimulation, entertainment, and amusement. The most popular and successful toys are those that continue to stimulate, entertain, and amuse long after the player is first introduced to the toy. A toy that operates in a predictable way or that provides for little interaction with the player will quickly be abandoned.

Musical toys are typically designed with sound chips programmed to play the musical notes of prerecorded songs when activated. The player activates such a musical toy by simply engaging a switch which causes the toy to automatically play the musical notes of a prerecorded song. Because the toy requires no further action on the part of the player, the player can easily become bored with the musical toy.

### BRIEF SUMMARY

An objective of the disclosed invention is to provide a musical toy which will continue to stimulate, entertain, and amuse the player long after initial exposure to the toy. In the disclosed invention, the toy outputs sound effects, such as the musical notes of a familiar prerecorded song, only through sustained manual operation by the player or players. In one exemplary embodiment, a vibration-activated musical toy comprises two preferably bell-shaped separate modules. Contained within each separate module of the vibration-activated musical toy is a vibration sensor and a sound generating system electrically connected to the vibration sensor. The sound generating system includes a sound chip programmed to play every other note, beginning with either the first note or the second note, of a series of musical notes from a familiar prerecorded song. In the preferred method of operation, a player holds one module in each hand. The player shakes the first module, activating the vibration sensor in that module and causing the sound generating system in that module to play the first musical note in its programmed series. This note corresponds to the first musical note in the prerecorded song. The player then shakes the second module, activating the vibration sensor in that module and causing the sound generating system in that module to play the first musical note in its programmed series. This note corresponds to the second musical note in the prerecorded song. The player then again shakes the first module, again activating the vibration sensor in that module and causing the sound generating system in that module to play the second musical note in its programmed series. This note corresponds to the third musical note in the prerecorded song. The player continues to alternate between shaking the first module and the second module until all musical notes in the prerecorded song have been played. When the modules of the vibration-activated musical toy are alternatively moved or shaken in the familiar rhythm of the prerecorded song, the vibration-activated musical toy will play the entire song.

The disclosed vibration-activated musical toy is superior to prior-art musical toys in that the player must practice to acquire the necessary skill to correctly play the prerecorded song or other sound effects. Rather than simply engaging a switch to hear a song, the player must move, shake, strike, or otherwise manipulate the separate modules of the vibration-activated musical toy in the correct order and with the correct rhythm to hear the entire song. Consequently the disclosed vibration-activated musical toy will continue to stimulate, entertain, and amuse long after the player is first introduced to the toy.

### BRIEF DESCRIPTION OF THE DRAWINGS

Reference is now made to the following descriptions taken in conjunction with the accompanying drawings.

FIG. 1 illustrates the external structure of one embodiment of a vibration-activated musical toy;

FIG. 2 illustrates the internal structure of one embodiment of a vibration-activated musical toy; and

FIG. 3 illustrates the electrical circuit of one embodiment of a vibration-activated musical toy.

### DETAILED DESCRIPTION

Various aspects of a vibration-activated musical toy according to the present disclosure are described. It is to be understood, however, that the following explanation is merely exemplary in describing the vibration-activated musical toy of the present disclosure. Accordingly, several modifications, changes, and substitutions are contemplated.

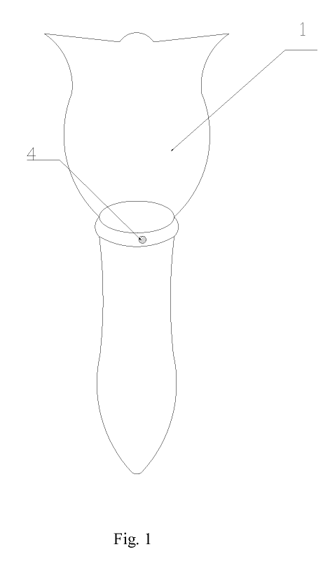

FIG. 1 illustrates the external structure of one embodiment of a vibration-activated musical toy. In this embodiment, each module comprises an external housing 1 in the shape of a bell, although other shapes are also contemplated. In the preferred embodiment, the modules share an identical external structure. The external housing can be made of any material suitable for enclosing electronics, such as plastic, metal, or other material. In some embodiments, there may be a light emitting device, such as a light-emitting diode (LED), mounted on external housing 1. Further, some embodiments may have buttons, switches, or other selection or activation devices 4 mounted on the external housing. These devices include, but are not limited to, a power activation device, such as an on/off switch, a reset device to return the module to a preset configuration, and various selection devices. Selection devices, such as buttons or switches, may be used in some embodiments to configure the vibration-activated musical toy to operate in one or more of a variety of predefined ways. These selection devices provide the user with the ability to control the operation of the vibration-activated musical toy. In one example, if the musical toy is programmed with a plurality of prerecorded songs, a selection device can be used to configure the toy to play a particular prerecorded song. In a second example, if the musical toy is programmed with a plurality of series of musical notes from a prerecorded song, a selection device can be used to configure the toy to play a particular series of musical notes from a prerecorded song. In a third example, if the musical toy is programmed to output sound effects in a plurality of sound formats, a selection device can be used to configure the toy to play sound effects in a particular sound format.

Although in the preferred embodiment, the modules are completely separate from one another, it is contemplated that the modules could be flexibly connected to one another. In such an embodiment, the modules could be connected with string, cord, wire, chain, cable, or in any manner that allows for substantial freedom of movement of each module in relation to the other.

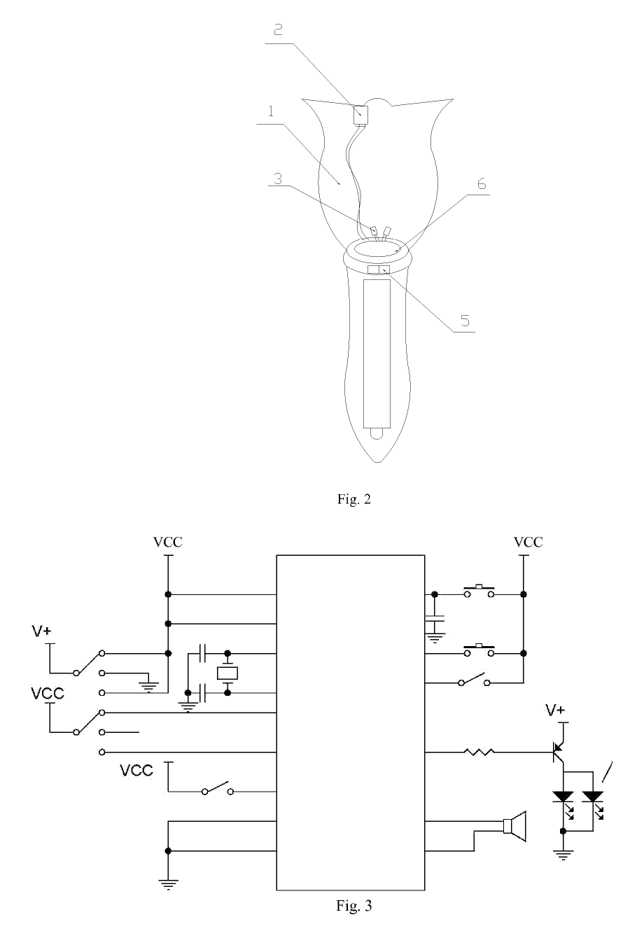

FIG. 2 illustrates the internal structure of one embodiment of a vibration-activated musical toy. In this embodiment, each separate module comprises external housing 1, sound generating system 6 disposed within external housing 1, vibration sensor 2 disposed within external housing 1, and a power source disposed within external housing 1. Also disposed within external housing 1 is the electrical circuit necessary to interconnect the various electrical components. Vibration sensor 2, sound generating system 6, and the power source are electrically connected by the electrical circuit. In some embodiments, light emitting device 3 may be mounted on external housing 1 and electrically coupled to vibration sensor 2. In the preferred embodiment, light emitting device 3 comprises a light-emitting diode (LED).

Vibration sensor 2 is activated whenever external housing 1 is moved, shaken, struck, or otherwise manipulated. Vibration sensor 2 then sends a signal to sound generating system 6 via the electrical circuit. Upon receiving the signal, sound generating system 6 outputs a sound effect and causes light emitting device 3, installed in some embodiments, to emit light substantially simultaneously with the output of the sound effect.

In the preferred embodiment, the sound effects output by sound generating system 6 are musical notes, though other sound effects are contemplated. These sound effects can be output in a variety of sound formats, resulting in the sound effects output by the toy simulating sounds including, but not limited to, bells, whistles, human sounds, animal sounds, and musical instruments, such as piano, flute, large handbell, or small handbell. In some embodiments, sound generating system 6 outputs sound effects in a user-selectable variety of sound formats. In these embodiments, a selection device is included to enable the user to configure the musical toy to simulate the desired sound. In the preferred embodiment, the sound generating system 6 of both modules outputs sound effects in a handbell sound format.

In one embodiment, sound generating system 6 comprises a sound chip programmed with one or more series of musical notes from one or more prerecorded songs. If the sound chip is programmed with more than one series of musical notes, a selection device may be used to configure the toy to play a particular series.

In a preferred embodiment of the disclosed invention, the sound chip of one separate module of the vibration-activated musical toy is programmed to play the odd series of musical notes for a prerecorded song, while the sound chip of the other separate module of the vibration-activated musical toy is programmed to play the even series of musical notes for the same prerecorded song. When the two separate modules are moved, shaken, or otherwise manipulated in a particular order corresponding to the rhythm of the prerecorded song, the vibration-activated musical toy will play the entire song. For example, suppose an entire song consists of the musical note series “1, 2, 3, 4, 5, 6, 7, 8, 9, 10.” In this embodiment, the sound chip of the first separate module is programmed to play prerecorded musical note series “1, 3, 5, 7, 9” while the sound chip of the second separate module is programmed to play prerecorded musical note series “2, 4, 6, 8, 10.” To hear the entire song, a player manipulates the first module, causing the sound generating system of the first module to output musical note “1.” The player then manipulates the second module, causing the sound generating system of the second module to output musical note “2.” The player then manipulates the first module again, cause the sound generating system of the first module to output musical note “3.” Play continues, alternating between manipulation of the first module and the second module, until all ten musical notes have been output, and the entire song has been played.

In another embodiment of the disclosed invention, the sound chips of both modules of the vibration-activated musical toy are programmed to play both the odd series of musical notes and the even series of musical notes for an entire prerecorded song. In this embodiment, a mode selection device installed on external housing 1 controls whether the module plays the odd series of musical notes or the even series of musical notes when activated by a player. For example, suppose an entire song consists of the musical notes “1, 2, 3, 4, 5, 6, 7, 8, 9, 10.” Through the mode selection device, both modules of the vibration-activated musical toy can be configured to play either prerecorded musical note series “1, 3, 5, 7, 9” or prerecorded musical note series “2, 4, 6, 8, 10.” This embodiment is advantageous from a manufacturing standpoint in that only one product line is required. This embodiment is advantageous from a consumer standpoint in that a lost or damaged module may be replaced without regard to whether the module plays the odd series of musical notes or the even series of musical notes.

In a preferred embodiment of the invention, the sound chip is programmed with series of musical notes from more than one prerecorded song. In such an embodiment, the musical toy will play a series of musical notes from each prerecorded song in succession, looping back to replay the series of musical notes from the first prerecorded song after all series have been played. In an alternative embodiment, a selection device mounted on external housing 1 can be used to configure the toy to play musical notes from a particular prerecorded song.

FIG. 3 shows a schematic of the electrical circuit of a preferred embodiment of the disclosed invention. Vibration sensor electronics 10, sound generating system electronics 20, light emitting device electronics 30, and power source electronics 40 are electrically connected and controlled through microcontroller 50. After power source electronics 40 are engaged, when a module is manipulated such that the contact switches in vibration sensor electronics 10 are engaged, a signal is sent to microcontroller 50. Microcontroller 50 then signals sound generating system electronics 20 to output a sound effect. In this embodiment, microcontroller 50 also signals light emitting device electronics 30 to emit light substantially simultaneously with the output of the sound effect, although some embodiments contemplated do not include the light emitting device.

Generally, two or more modules are required to operate the vibration-activated musical toy. In a preferred method of operation, two modules are required. After the power sources for both modules are engaged, the player moves or shakes the first module, thus activating vibration sensor 2 located within the first module and causing the first module to output a first sound effect. The player then moves or shakes the second module, thus activating vibration sensor 2 located within the second module and causing the second module to output a second sound effect. The player continues to alternate moving or shaking the modules, causing the modules to output sound effects. In a preferred embodiment, the sound effects comprise the musical notes of a song, and the preferred method of operation results in the output of a song. Should the player desire to restore one or both modules to a preset configuration, the player can either disengage the power source, and then re-engage it, or, in some embodiments, activate the reset button.

While various embodiments of vibration-activated musical toys and related methods of operating vibration-activated musical toys have been described above, it should be understood that they have been presented by way of example only, and not limitation. Thus, the breadth and scope of the invention should not be limited by any of the above-described exemplary embodiments, but should be defined only in accordance with the following claims and their equivalents. Moreover, the above advantages and features are provided in described embodiments, but shall not limit the application of the claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in the claims found herein. Furthermore, any reference in this disclosure to “invention” in the singular should not be used to argue that there is only a single point of novelty claimed in this disclosure. Multiple inventions may be set forth according to the limitations of the multiple claims associated with this disclosure, and the claims accordingly define the invention(s), and their equivalents, that are protected thereby. In all instances, the scope of the claims shall be considered on their own merits in light of the specification, but should not be constrained by the headings set forth herein.

What is claimed is:

1. A musical toy for outputting sound effects, the musical toy comprising a first module and a second module, the first and second modules being separate, substantially disconnected articles, the first module comprising:
a first external housing;
a first power source disposed within the first external housing;
a first vibration sensor disposed within the first external housing and electrically coupled to the first power source, the first vibration sensor activated when the first external housing is manipulated; and
a first sound generating system disposed within the first external housing and electrically coupled to the first vibration sensor, wherein the first sound generating system outputs a sound effect in response to the activation of the first vibration sensor; and the second module comprising:
a second external housing;
a second power source disposed within the second external housing;
a second vibration sensor disposed within the second external housing and electrically coupled to the second power source, the second vibration sensor activated when the second external housing is manipulated; and
a second sound generating system disposed within the second external housing and electrically coupled to the second vibration sensor, wherein the second sound generating system outputs a sound effect in response to the activation of the second vibration sensor.

2. The musical toy of claim 1, wherein the first and second modules being separate, substantially disconnected articles comprises the first and second modules being joined by a flexible connection allowing each module a substantial freedom of motion relative to the alternative module.

3. The musical toy of claim 2, wherein the flexible connection is selected from the group consisting of a string, a rope, a cord, a wire, a chain, and a cable.

4. The musical toy of claim 1, wherein at least one of the first and second external housings comprises a bell shape.

5. The musical toy of claim 1, the first module further comprising a first light emitting device mounted on the first external housing and electrically coupled to the first vibration sensor, and the second module further comprising a second light emitting device mounted on the second external housing and electrically coupled to the second vibration sensor, wherein the first light emitting device emits light in response to the activation of the first vibration sensor and the second light emitting device emits light in response to the activation of the second vibration sensor, such that the light from at least one of the first and second light emitting devices is emitted substantially simultaneously with the output of the sound effect from the corresponding sound generating system.

6. The musical toy of claim 5, wherein at least one of the first and second light emitting devices comprises a light-emitting diode (LED).

7. The musical toy of claim 1, wherein each of the first and second sound generating systems is operable to output sound effects in at least one of a plurality of sound formats, the first module further comprising a first format selection device mounted on the first external housing and the second module further comprising a second format selection device mounted on the second external housing, wherein the first format selection device is used to configure the first sound generating system to output sound effects in a first sound format, and the second format selection device is used to configure the second sound generating system to output sound effects in a second sound format.

8. The musical toy of claim 7, wherein the second sound format is the same format as the first sound format.

9. The musical toy of claim 7, wherein at least one of the first and second format selection devices comprises a switch.

10. The musical toy of claim 7, wherein the plurality of sound formats comprises a plurality of musical instrument sound formats.

11. The musical toy of claim 10, wherein the plurality of musical instrument sound formats comprises a large bell sound format and a small bell sound format.

12. The musical toy of claim 1, wherein the first sound generating system comprises a first sound chip and the second sound generating system comprises a second sound chip, the first and second sound chips programmed with at least one of a plurality of series of musical notes from at least one of a plurality of prerecorded songs, and wherein each of the first and second sound effects comprises a musical note from the at least one series of musical notes from the at least one prerecorded song.

13. The musical toy of claim 12, wherein the first sound chip is programmed with a first series of musical notes from the at least one prerecorded song, and the second sound chip is programmed with a second series of musical notes from the at least one prerecorded song.

14. The musical toy of claim 13, wherein the first series of musical notes comprises every other note, beginning with the first note, from the at least one prerecorded song, and the second series of musical notes comprises every other note, beginning with the second note, from the at least one prerecorded song.

15. The musical toy of claim 12, wherein each of the first and second sound chips is programmed with both a first series of musical notes from the at least one prerecorded song and a second series of musical notes from the at least one prerecorded song, the first module further comprising a first mode selection device mounted on the first external housing and the second module further comprising a second mode selection device mounted on the second external housing, wherein the first mode selection device is used to configure the first sound generating system to output a musical note from either the first series or the second series of musical notes, and the second mode selection device is used to configure the second sound generating system to output a musical note from either the first series or the second series of musical notes.

16. The musical toy of claim 15, wherein the first series of musical notes comprises every other note, beginning with the first note, from the at least one prerecorded song, and the second series of musical notes comprises every other note, beginning with the second note, from the at least one prerecorded song.

17. The musical toy of claim 15, wherein at least one of the first and second mode selection devices comprises a switch.

18. The musical toy of claim 12, wherein each of the first and second sound chips is programmed with a plurality of series of musical notes from the plurality of prerecorded songs, the first module further comprising a first song selection device mounted on the first external housing and the second module further comprising a second song selection device mounted on the second external housing, wherein the first song selection device is used to configure the first sound generating system to output a musical note from one of the plurality of prerecorded songs and the second song selection device is used to configure the second sound generating system to output a musical note from one of the plurality of prerecorded songs.

19. The musical toy of claim 18, wherein at least one of the first and second song selection devices comprises a switch.

20. A musical toy for outputting the notes of prerecorded songs in a bell sound format, the musical toy comprising a first module and a second module, the first and second modules being separate, substantially disconnected articles, the first module comprising:
a first external housing comprising a bell shape;
a first power source disposed within the first external housing;
a first power activation device mounted on the first external housing used to activate the first power source;
a first vibration sensor disposed within the first external housing, the first vibration sensor electrically coupled to the first power source and activated when the first external housing is manipulated;
a first sound generating system disposed within the first external housing and electrically coupled to the first vibration sensor, the first sound generating system comprising a first sound chip, wherein the first sound chip is programmed with a first ordered plurality of series of musical notes from an ordered plurality of prerecorded songs, wherein the first series in the first ordered plurality of series of musical notes comprises every other note, beginning with the first note, from the first song in the ordered plurality of prerecorded songs, wherein the last series in the first ordered plurality of series of musical notes comprises every other note, beginning with the first note, from the last song in the ordered plurality of prerecorded songs, wherein each intervening series in the first ordered plurality of series of musical notes comprises every other note, beginning with the first note, from the corresponding intervening song in the ordered plurality of prerecorded songs, and wherein the first sound generating system outputs the first note from the first series in the first ordered plurality of series of musical notes in response to the first activation of the first vibration sensor following the activation of the first power source, further outputs the second note from the first series in the first ordered plurality of series of musical notes in response to the second activation of the first vibration sensor following the activation of the first power source, and continues to further output consecutive notes from the first ordered plurality of series of musical notes in response to successive activations of the first vibration sensor, looping back to output the first note from the first series in the first ordered plurality of series of musical notes in response to the next activation of the first vibration sensor following the output of the last note from the last series in the first ordered plurality of series of musical notes;
a first reset device mounted on the first external housing and electrically coupled to the first sound generating system, the first reset device used to reconfigure the first sound generating system to output the first note from the first series in the first ordered plurality of series of musical notes in response to the next activation of the first vibration sensor;
and the second module comprising:
a second external housing comprising a bell shape;
a second power source disposed within the second external housing;
a second power activation device mounted on the second external housing used to activate the second power source;
a second vibration sensor disposed within the second external housing, the second vibration sensor electrically coupled to the second power source and activated when the second external housing is manipulated;
a second sound generating system disposed within the second external housing and electrically coupled to the second vibration sensor, the second sound generating system comprising a second sound chip, wherein the second sound chip is programmed with a second ordered plurality of series of musical notes from the ordered plurality of prerecorded songs, wherein the first series in the second ordered plurality of series of musical notes comprises every other note, beginning with the second note, from the first song in the ordered plurality of prerecorded songs, wherein the last series in the second ordered plurality of series of musical notes comprises every other note, beginning with the second note, from the last song in the ordered plurality of prerecorded songs, wherein each intervening series in the second ordered plurality of series of musical notes comprises every other note, beginning with the second note, from the corresponding intervening song in the ordered plurality of prerecorded songs, and wherein the second sound generating system outputs the first note from the first series in the second ordered plurality of series of musical notes in response to the first activation of the second vibration sensor following the activation of the second power source, further outputs the second note from the first series in the second ordered plurality of series of musical notes in response to the second activation of the second vibration sensor following the activation of the second power source, and continues to further output consecutive notes from the second ordered plurality of series of musical notes in response to successive activations of the second vibration sensor, looping back to output the first note from the first series in the second ordered plurality of series of musical notes in response to the next activation of the second vibration sensor following the output of the last note from the last series in the second ordered plurality of series of musical notes; and
a second reset device mounted on the second external housing and electrically coupled to the second sound generating system, the second reset device used to reconfigure the second sound generating system to output the first note from the first series in the second ordered plurality of series of musical notes in response to the next activation of the second vibration sensor.

21. The musical toy of claim 1, the first module further comprising a first light emitting device mounted on the first external housing and electrically coupled to the first vibration sensor, and the second module further comprising a second light emitting device mounted on the second external housing and electrically coupled to the second vibration sensor, wherein the first light emitting device emits light in response to the activation of the first vibration sensor and the second light emitting device emits light in response to the activation of the second vibration sensor, such that the light from each of the first and second light emitting devices is emitted substantially simultaneously with the output of the musical note from the corresponding sound generating system.

22. A method of operating a musical toy to produce at least one of a plurality of series of logically related sound effects, the musical toy comprising a first module and a second module, the first and second modules being separate, substantially disconnected articles, the method comprising:
manipulating the first module, the manipulation causing the first module to output a first sound effect;
manipulating the second module, the manipulation causing the second module to output a second sound effect, the second sound effect having a logical relationship to the first sound effect; and
continuing to alternate between manipulating the first and second modules, each manipulation causing the manipulated module to output a sound effect having a logical relationship to the sound effect produced in response to the previous manipulation of the alternative module.

23. The method of claim 22, wherein the manipulation of at least one of the first and second modules comprises moving the module.

24. The method of claim 22, wherein the manipulation of at least one of the first and second modules comprises striking the module.

25. The method of claim 22, further comprising:
configuring the first module to output sound effects in a first sound format; and
configuring the second module to output sound effects in a second sound format.

26. The method of claim 22, wherein the plurality of series of logically related sound effects comprises a plurality of series of musical notes from at least one of a plurality of prerecorded songs.

27. The method of claim 26, further comprising:
configuring the first module to output a first series of musical notes from the at least one prerecorded song; and
configuring the second module to output a second series of musical notes from the at least one prerecorded song.

28. The method of claim 27, wherein the first series of musical notes comprises every other note, beginning with the first note, from the at least one prerecorded song, and the second series of musical notes comprises every other note, beginning with the second note, from the at least one prerecorded song.

29. The method of claim 26, further comprising:
configuring the first module to output a series of musical notes from a first prerecorded song; and
configuring the second module to output a series of musical notes from a second prerecorded song.

30. The method of claim 29, wherein the second prerecorded song is the same song as the first prerecorded song.
